(19) United States
(12) Patent Application Publication
(10) Pub. No.: US 2026/0311308 A1
(43) Pub. Date: Oct. 8, 2026

(54) ADAPTIVE CAMERA MODELS FOR IMAGE ENHANCEMENT IN VIDEO SEE-THROUGH (VST) EXTENDED REALITY (XR) OR OTHER APPLICATIONS

(71) Applicant: Samsung Electronics Co., Ltd., Suwon-si (KR)

(72) Inventor: Yingen Xiong, Mountain View, CA (US)

(21) Appl. No.: 19/455,622

(22) Filed: Jan. 21, 2026

Related U.S. Application Data
(60) Provisional application No. 63/785,395, filed on Apr. 8, 2025.

(51) Int. Cl. G06T 5/92; G06T 7/00

(52) U.S. Cl. CPC G06T 5/92; G06T 7/0002; G06T 2207/30168

(57) ABSTRACT

A method includes obtaining, using at least one processing device, image data including a sequence of image frames. The method also includes analyzing, using the at least one processing device, image visual quality of the image data and generating, using the at least one processing device, an adaptive camera model by modeling a light environment associated with the image data. The method further includes generating, using the at least one processing device, an adaptive exposure ratio map by modeling the light environment associated with the image data and performing, using the at least one processing device, image enhancement using the adaptive camera model and the adaptive exposure ratio map to produce enhanced image data. In addition, the method includes generating, using the at least one processing device, final view frames based on the enhanced image data and initiating display of the final view frames on at least one display.

### CROSS-REFERENCE TO RELATED APPLICATION AND PRIORITY CLAIM

This application claims priority under 35 U.S.C. § 119(e) to U.S. Provisional Patent Application No. 63/785,395 filed on Apr. 8, 2025, which is hereby incorporated by reference in its entirety.

### TECHNICAL FIELD

This disclosure relates generally to imaging systems and processes. More specifically, this disclosure relates to adaptive camera models for image enhancement in video see-through (VST) extended reality (XR) or other applications.

### BACKGROUND

Extended reality (XR) systems are becoming more and more popular over time, and numerous applications have been and are being developed for XR systems. Some XR systems (such as augmented reality or “AR” systems and mixed reality or “MR” systems) can enhance a user's view of his or her current environment by overlaying digital content (such as information or virtual objects) over the user's view of the current environment. For example, some XR systems can often seamlessly blend virtual objects generated by computer graphics with real-world scenes.

### SUMMARY

This disclosure relates to adaptive camera models for image enhancement in video see-through (VST) extended reality (XR) or other applications.

In a first embodiment, a method includes obtaining, using at least one processing device of an electronic device, image data including a sequence of image frames. The method also includes analyzing, using the at least one processing device, image visual quality of the image data and generating, using the at least one processing device, an adaptive camera model by modeling a light environment associated with the image data. The method further includes generating, using the at least one processing device, an adaptive exposure ratio map by modeling the light environment associated with the image data and performing, using the at least one processing device, image enhancement using the adaptive camera model and the adaptive exposure ratio map to produce enhanced image data. In addition, the method includes generating, using the at least one processing device, final view frames based on the enhanced image data and initiating display of the final view frames on at least one display.

In a second embodiment, an electronic device includes at least one processing device configured to obtain image data including a sequence of image frames, analyze image visual quality of the image data, and generate an adaptive camera model by modeling a light environment associated with the image data. The at least one processing device is also configured to generate an adaptive exposure ratio map by modeling the light environment associated with the image data and perform image enhancement using the adaptive camera model and the adaptive exposure ratio map to produce enhanced image data. The at least one processing device is further configured to generate final view frames based on the enhanced image data and initiate display of the final view frames on at least one display.

In a third embodiment, a non-transitory machine readable medium contains instructions that when executed cause at least one processor of an electronic device to obtain image data including a sequence of color image frames, analyze image visual quality of the image data, and generate an adaptive camera model by modeling a light environment associated with the image data. The non-transitory machine readable medium also contains instructions that when executed cause the at least one processor to generate an adaptive exposure ratio map by modeling the light environment associated with the image data and perform image enhancement using the adaptive camera model and the adaptive exposure ratio map to produce enhanced image data. The non-transitory machine readable medium further contains instructions that when executed cause the at least one processor to generate final view frames based on the enhanced image data and initiate display of the final view frames on at least one display.

Any single one or any combination of the following features may be used with the disclosed embodiments. The adaptive camera model may be generated by generating one or more camera response models, generating one or more image brightness transformation models, determining one or more dynamic parameters, and generating the adaptive camera model based on the one or more camera response models, the one or more image brightness transformation models, and the one or more dynamic parameters.

The adaptive exposure ratio map may be generated by creating a solver for a minimization problem, determining an illumination map using the solver, determining an exposure ratio map using the illumination map, and generating the adaptive exposure ratio map based on the exposure ratio map and one or more dynamic parameters.

The image enhancement may be performed by determining a camera response model and a brightness transformation model, generating an enhanced image using the camera response model, the brightness transformation model, and the adaptive exposure ratio map, and adjusting brightness of the image data.

The adaptive camera model may be generated using a Beta-Gamma model or a Sigmoid model.

The electronic device may represent a head-mounted device configured to capture a scene using at least one camera and present corresponding images on the at least one display.

The at least one camera may include at least one see-through camera.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a drier, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include new electronic devices depending on the development of technology.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIG. 1 illustrates an example network configuration including an electronic device according to this disclosure;

FIG. 2 illustrates an example high-level process for using adaptive camera models for image enhancement in accordance with this disclosure;

FIG. 3 illustrates an example process for using adaptive camera models for image enhancement that can accommodate camera model calibration in accordance with this disclosure;

FIG. 4 illustrates an example process for using adaptive camera models for selective image enhancement in real-time video see-through (VST) extended reality (XR) or other applications in accordance with this disclosure; and

FIG. 5 illustrates an example method for adaptive camera models for image enhancement in VST XR or other applications in accordance with this disclosure.

### DETAILED DESCRIPTION

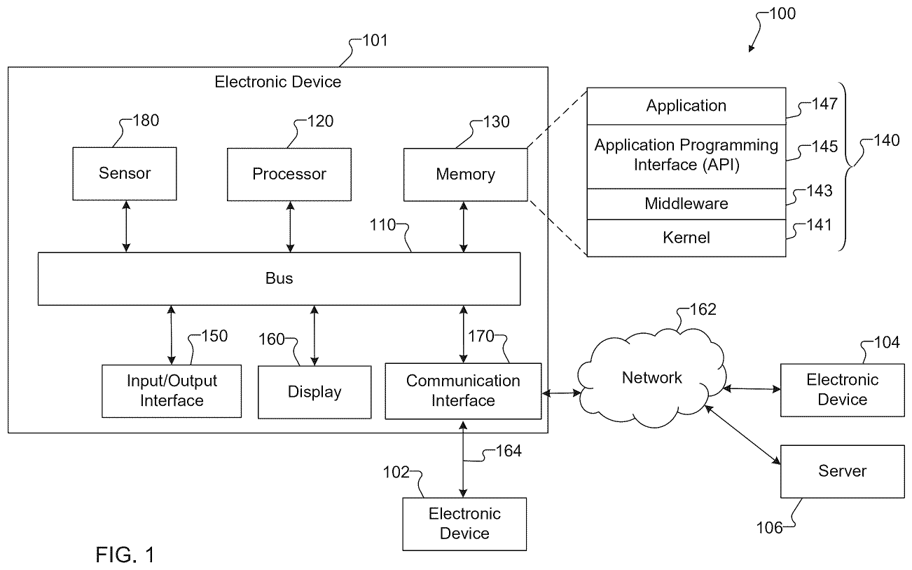

FIGS. 1 through 5, discussed below, and the various embodiments of this disclosure are described with reference to the accompanying drawings. However, it should be appreciated that this disclosure is not limited to these embodiments and all changes and/or equivalents or replacements thereto also belong to the scope of this disclosure.

As noted above, extended reality (XR) systems are becoming more and more popular over time, and numerous applications have been and are being developed for XR systems. Some XR systems (such as augmented reality or “AR” systems and mixed reality or “MR” systems) can enhance a user's view of his or her current environment by overlaying digital content (such as information or virtual objects) over the user's view of the current environment. For example, some XR systems can often seamlessly blend virtual objects generated by computer graphics with real-world scenes.

Optical see-through (OST) XR systems refer to XR systems in which users directly view real-world scenes through head-mounted devices (HMDs). Unfortunately, OST XR systems face many challenges that can limit their adoption. Some of these challenges include limited fields of view, limited usage spaces (such as indoor-only usage), failure to display fully-opaque black objects, and usage of complicated optical pipelines that may require projectors, waveguides, and other optical elements. In contrast to OST XR systems, video see-through (VST) XR systems (also called “passthrough” XR systems) present users with generated video sequences of real-world scenes. VST XR systems can be built using virtual reality (VR) technologies and can have various advantages over OST XR systems. For example, VST XR systems can provide wider fields of view and can provide improved contextual augmented reality.

A VST XR device often includes one or more imaging sensors (also called “see-through cameras”) that capture high-resolution image frames of a user's surrounding environment. These image frames are processed in an image processing pipeline in order to generate final rendered views of the user's surrounding environment. Because a user views the world through cameras and displays, VST XR offers strengths and trade-offs. Example advantages can include pixel-perfect compositing, richer interactions with real objects via depth sensing, and easier integration with standard computer vision pipelines and safety interlocks (such as blurring or masking sensitive areas). Example constraints can include latency (camera capture to display pipeline), potential visual discomfort if timing or alignment drifts, power and thermal demands for constant processing, and possible image quality limits under low light or high dynamic range scenes. Compared with OST systems, VST systems can deliver more faithful occlusion and effects, but VST systems rely heavily on camera and display performance to maintain realism and user comfort. Ideally, VST systems should be able to be used in different light environments, including low-light, normal light, and strong light environments. In current systems, however, images generated in low-light environments appear to have low brightness, low contrast, and are noisy, which makes it difficult for the user to perceive captured content.

This disclosure provides various techniques supporting adaptive camera models for image enhancement in VST XR or other applications. For example, as described in more detail below, one disclosed process includes creating one or more adaptive camera models with dynamic parameters to fit a light environment while capturing see-through frames. The adaptive camera model(s) can include a camera response function and a brightness transformation function. The process can include computing the model parameters dynamically from the see-through frames. For each individual frame, the process can include creating an exposure ratio map for re-creating brightness and contrast for individual pixels such that the image visual quality can be enhanced pixel-by-pixel. After local enhancement, the process can include enhancing the brightness globally for a whole frame with exposure adjustment. After image enhancement, the process can include providing final view frames with improved image visual quality to a user. In this way, the VST systems can be used in different light environments while providing improved image visual quality.

FIG. 1 illustrates an example network configuration 100 including an electronic device in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, and a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), a graphics processor unit (GPU), or a neural processing unit (NPU). The processor 120 is able to perform control on at least one of the other components of the electronic device 101 and/or perform an operation or data processing relating to communication or other functions. As described below, the processor 120 may perform one or more functions related to adaptive camera models for image enhancement in VST XR or other applications, such as by using an adaptive camera model and an adaptive exposure ratio map to perform image enhancement.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may include one or more applications that, among other things, perform one or more functions related to adaptive camera models for image enhancement in VST XR or other applications, such as by using an adaptive camera model and an adaptive exposure ratio map to perform image enhancement. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, the sensor(s) 180 can include one or more cameras or other imaging sensors, which may be used to capture images of scenes. The sensor(s) 180 can also include one or more buttons for touch input, one or more microphones, a depth sensor, a gesture sensor, a gyroscope or gyro sensor, an air pressure sensor, a magnetic sensor or magnetometer, an acceleration sensor or accelerometer, a grip sensor, a proximity sensor, a color sensor (such as a red green blue (RGB) sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. Moreover, the sensor(s) 180 can include one or more position sensors, such as an inertial measurement unit that can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the electronic device 101 can be a wearable device or an electronic device-mountable wearable device (such as an HMD). For example, the electronic device 101 may represent an XR wearable device, such as a headset or smart eyeglasses. In other embodiments, the first external electronic device 102 or the second external electronic device 104 can be a wearable device or an electronic device-mountable wearable device (such as an HMD). In those other embodiments, when the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving with a separate network.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components as the electronic device 101 (or a suitable subset thereof). The server 106 can support to drive the electronic device 101 by performing at least one of operations (or functions) implemented on the electronic device 101. For example, the server 106 can include a processing module or processor that may support the processor 120 implemented in the electronic device 101. As described below, the server 106 may perform one or more functions related to adaptive camera models for image enhancement in VST XR or other applications, such as by using an adaptive camera model and an adaptive exposure ratio map to perform image enhancement.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

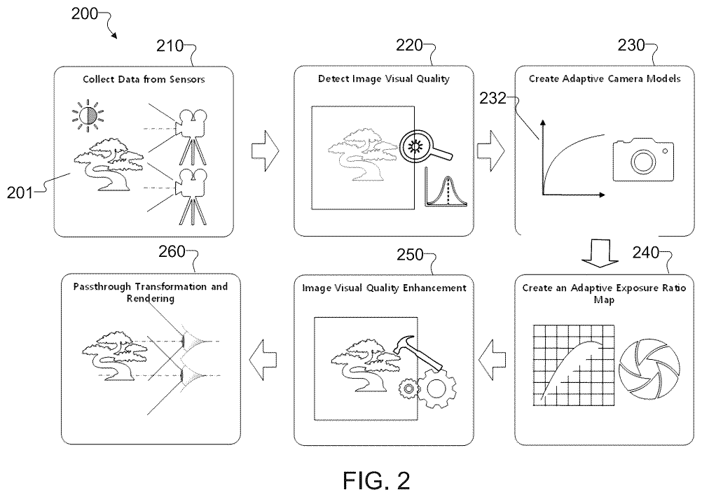

FIG. 2 illustrates an example high-level process 200 for using adaptive camera models for image enhancement in accordance with this disclosure. For ease of explanation, the process 200 of FIG. 2 is described as being implemented using the electronic device 101 in the network configuration 100 of FIG. 1. However, the process 200 may be implemented using any other suitable device(s) (such as the server 106) and in any other suitable system(s).

As shown in FIG. 2, adaptive camera models are applied in a VST XR pipeline for image enhancement of see-through image frames by the electronic device 101. The video see-through pipeline can be implemented, for example, using one or more processors 120 of the electronic device 101, and the enhanced images can be displayed on one or more displays 160 of the electronic device 101 or used in any other suitable manner.

In this example, the process 200 includes collecting image data from sensors, such as one or more sensors 180, at step 210. The image data collected, represented here as image data 201, could include high-resolution color frames from camera sensors, depth data from depth sensors, eye tracking frames from eye tracking cameras, and/or head pose data from positional sensors, any or all of which can be implemented by the sensors 180 of the electronic device 101. In some cases, the image data can include a sequence of image frames, including color image frames. The image data represents a real-world scene intended for passthrough display to a user.

The process 200 also includes detecting and analyzing image visual quality information of the image data at step 220, which can be done to support image enhancement. The image visual quality information can include, for example, image brightness, image contrast, and/or image signal-to-noise ratio (SNR). In some embodiments, the image visual quality information can include one or more dynamic parameters as described below. This analysis may include computing global and local brightness levels, contrast distributions, and signal-to-noise ratio values for the image frames. The analysis may further include deriving image statistics, such as channel-wise means and standard deviations, which characterize the lighting conditions and dynamic range of the scene.

The process 200 further includes creating adaptive camera models 232 to fit the input data at step 230. In some cases, the adaptive camera models can be created by modeling the light environment of the image data 201 using the dynamic parameters. The adaptive camera models are configured to account for variations in illumination, exposure, and camera characteristics.

The process 200 also includes creating an adaptive exposure ratio map with dynamic parameters to fit the input images at step 240. In some cases, the adaptive exposure ratio map can be created by modeling the light environment of the image data 201 (such as the scene captured in the image data) for image visual quality enhancement. Example techniques for creating the adaptive camera models and the adaptive exposure ratio maps are provided below. This step may include estimating an illumination map from the image data and deriving spatially varying exposure ratios that enable pixel-level or region-level brightness and contrast adjustment.

The process 200 further includes making image enhancements to the image data to create enhanced image data at step 250. For example, the image enhancements can be performed using the adaptive camera models and the adaptive exposure ratio maps to improve image brightness and/or image contrast and to adaptively adjust brightness for the whole input image represented by the image data. This enhancement may include applying nonlinear brightness transformations, adjusting contrast, and selectively amplifying darker regions of the image while preserving overall scene structure.

In addition, the process 200 includes generating and rendering an output image, which can include applying one or more passthrough transformations, and displaying the output image at step 260. This step may include distortion correction or other display-related processing prior to presenting the enhanced image frames to the user.

Although FIG. 2 illustrates one example of a high-level process 200 for using adaptive camera models for image enhancement, various changes may be made to FIG. 2. For example, while shown as a series of steps, various steps in FIG. 2 could overlap, occur in parallel, occur in a different order, or occur any number of times (including zero times).

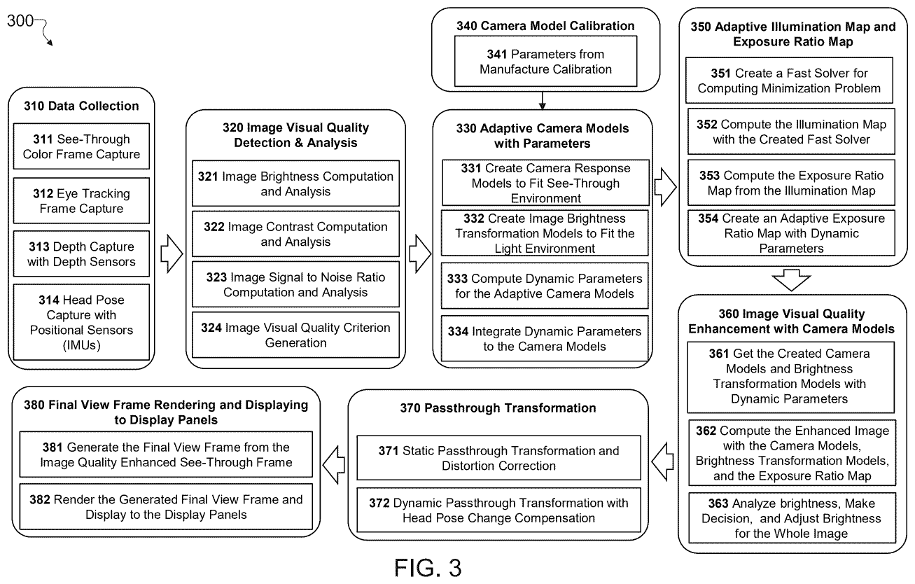

FIG. 3 illustrates an example process 300 for using adaptive camera models for image enhancement that can accommodate camera model calibration in accordance with this disclosure. For ease of explanation, the process 300 of FIG. 3 is described as being implemented using the electronic device 101 in the network configuration 100 of FIG. 1. However, the process 300 may be implemented using any other suitable device(s) (such as the server 106) and in any other suitable system(s). Also, the process 300 includes a specific implementation for adaptive camera models for image enhancement in VST XR or other applications. In particular, the process 300 includes a number of actions that are useful for illustrating this specific embodiment but are not necessary for all implementations.

As shown in FIG. 3, the process 300 includes primary actions of data collection at step 310, image visual quality detection and analysis at step 320, creating adaptive camera models with parameters at step 330, camera model calibration at step 340, creating adaptive illumination maps and exposure ratio maps at step 350, performing image visual quality enhancement with camera models at step 360, performing passthrough transformation at step 370, and final view frame rendering and displaying to display panels at step 380. Each of these primary actions may include a number of other actions as described below.

The electronic device 101 performs data collection at step 310. For example, step 310 can include capturing see-through color frames, such as with one or more high-resolution color cameras. at step 311. In some cases, the one or more high-resolution color cameras can be implemented using one or more of the sensors 180. Step 310 can also include capturing eye tracking frames with one or more eye tracking cameras at step 312. In some cases, the one or more eye tracking cameras can be implemented using one or more of the sensors 180. Step 310 can further include capturing depths with one or more depth sensors at step 313. In some cases, the one or more depth sensors can be implemented using one or more of the sensors 180. In addition, step 310 can include capturing head poses with one or more position sensors, such as one or more inertial measurement units (IMUs) at step 314. In some cases, the one or more position sensors can be implemented using one or more of the sensors 180. The collected data may be synchronized to support consistent image enhancement and passthrough rendering.

The electronic device 101 performs visual quality detection and analysis at step 320. For example, step 320 can include computing and analyzing image brightness at step 321, which can involve identifying image brightness in various portions of the color image frames. Step 320 can also include computing and analyzing image contrast at step 322, which can involve identifying image contrast in various portions of the color image frames. Step 320 can further include computing and analyzing image SNR at step 323, which can involve identifying SNR in various portions of the color image frames. In addition, step 320 can include generating image visual quality criteria for determining image visual quality, such as based on an image brightness criterion, an image contrast criterion, and/or an image SNR criterion, at step 324. Based on the analysis at step 320, the electronic device may generate image visual quality criteria that indicate whether enhancement is required and that guide the selection of enhancement parameters.

The electronic device 101 creates adaptive camera models with parameters at step 330. For example, step 330 can include creating camera response models to fit the see-through environment at step 331. Step 330 can also include creating image brightness transformation models to fit the light environment while using the electronic device 101 at step 332. Step 330 further can include computing dynamic parameters for adaptive camera models at step 333. In addition, step 330 can include integrating the dynamic parameters to the camera models at step 334. The dynamic parameters enable the camera models to adapt to changing lighting conditions. In some embodiments, when creating adaptive camera models at step 330, the electronic device 101 can use computed parameters and/or use model calibration data during step 340 with parameters from a manufacturer calibration 341.

The electronic device 101 creates adaptive illumination maps and exposure ratio maps at step 350. For example, step 350 can include creating a fast solver for computing a minimization problem at step 351, as described in more detail below. The minimization problem can use a guided filter to find an optimal illumination map represented as T(x) in the detailed description below. Step 350 can also include creating an illumination map with the fast solver at step 352, where the illumination map preserves scene structure while smoothing texture details. Step 350 can further include creating an exposure ratio map that specifies spatially varying exposure adjustments from the illumination map at step 353. In addition, step 350 can include creating an adaptive exposure ratio map with dynamic parameters at step 354.

The electronic device 101 performs image visual quality enhancement with the camera models at step 360. For example, step 360 can include obtaining the created camera models and brightness transformation models with dynamic parameters at step 361. Step 360 can also include creating the enhanced image with the camera models, brightness transformation models, and the exposure ratio map at step 362. Step 360 can further include analyzing the brightness and contrast of the enhanced image to determine whether it is necessary to adjust the brightness for the whole image and selectively adjusting the brightness of the whole image at step 363.

The electronic device 101 can perform at least one passthrough transformation at step 370. For example, step 370 can include performing a static passthrough transformation and distortion correction at step 371. Step 370 can also include performing a dynamic passthrough transformation with head pose change compensation at step 372. The electronic device 101 performs final view frame rendering and display to one or more display panels (such as one or more displays 160) at step 380. For example, step 380 can include generating the final view frame with an integrated transformation matrix at step 381. Step 380 can also include rendering the generated final view frame and initiating display to the display panels at step 382. “Initiating” display, as used here, can include sending instructions to display the final view frames to another processor or at least one display system, sending generated or rendered image data to at least one display system, or otherwise.

Although FIG. 3 illustrates one example of a process 300 for using adaptive camera models for image enhancement that can accommodate camera model calibration, various changes may be made to FIG. 3. For example, while shown as a series of steps, various steps in FIG. 3 could overlap, occur in parallel, occur in a different order, or occur any number of times (including zero times).

The disclosed processes can improve upon other approaches in various ways. For example, disclosed embodiments can create adaptive camera models with dynamic parameters to fit input images by modeling a light environment when capturing the images for image visual quality enhancement. Also, disclosed embodiments can create adaptive exposure ratio maps from the input images and adaptive camera models for enhancing brightness and contrast of the input images. In addition, disclosed embodiments can perform image enhancement with created adaptive camera models and adaptive exposure ratio maps to improve image brightness and image contrast and to adaptively adjust brightness for whole input images.

In some embodiments, an adaptive camera model can be defined as follows.

$$I ( x ) = ℛ ( E ( x ) )$$

Here, I(x) is a created image, E(x) is image irradiance, and [symbol] is a camera response function (CRF) that is related to camera properties. Also, in some embodiments, a brightness transformation model can be defined as follows.

$${I}_{1} ( x ) = ℱ ( {I}_{0} ( x ) , k )$$

Here, I₁(x) is an image created with an exposure e₁, I₁(x) is an image created with an exposure e₀, k is an exposure ratio, and [symbol] is a brightness transformation function (BTF) that is related to both camera properties and lighting environment while an image is captured.

Different camera models can be used for different low-light imaging in accordance with disclosed embodiments. For example, a Beta-Gamma model or a Sigmoid model can be used. In some embodiments, the Beta-Gamma camera model can be defined as follows.

$$\{ \begin{matrix}ℛ ( E ( x ) ) = {e}^{{β ( 1 - E ( x ) )}^{α}} \\ ℱ ( I ( x ) , k ) = {e}^{β ( 1 - {k}^{α} )} {I ( x )}^{{k}^{α}}\end{matrix}$$

Here, E(x) is image irradiance, I(x) is a created image, k is an exposure ratio, [symbol] is a camera response function, [symbol] is a brightness transformation function, and (α, β) are parameters for brightness and contrast control. Also, in some embodiments, the Sigmoid camera model can be defined as follows.

$$\{ \begin{matrix}ℛ ( E ( x ) ) = ( 1 + α ) \frac{{E ( x )}^{β}}{{E ( x )}^{β} + α} \\ ℱ ( I ( x ) , k ) = \frac{{k}^{β} I ( x ) ( 1 + α )}{( {k}^{β} - 1 ) I ( x ) + 1 + α}\end{matrix}$$

Here, E(x) is image irradiance, I(x) is a created image, k is an exposure ratio, [symbol] is a camera response function, [symbol] is a brightness transformation function, and (α, β) are parameters for brightness and contrast control.

In some camera models, the parameters α, β, and k can be useful or important for the generated images from low-light frames. As noted above, (α, β) are used for brightness control and contrast control, and k is the exposure ratio. For example, constant parameters (α, β) could be used for camera models when generating final images, such as the following.

$$\{ \begin{matrix}α = 0.9 \\ β = 0. 6\end{matrix}$$

One issue with using constant parameters (α, β) is that the adjustments of the brightness and contrast often cannot fit the original images best, which causes the resulting image to either still be too dark (adjustment is not enough) or too bright (adjustment is too much). As a particular example, applying constant parameters may make a generated image look correct for an input image of a given lighting, but generated images for brighter input images may become too bright. Using constant parameters (α, β) cannot generate adjustments of brightness and contrast for adaptively fitting different input images.

Disclosed embodiments here overcome this type of shortcoming by determining the parameters (α, β) of the camera models with camera and light environment while capturing the images. In some cases, this can be expressed as follows.

$$\{ \begin{matrix}α = f ( μ , σ ) \\ β = h ( μ , σ )\end{matrix}$$

Here, μ is a mean of an input image, and σ is a standard deviation of the input image. By using these equations, the parameters of camera models with image properties can be determined. For example, the parameters may be defined as follows.

$$\{ \begin{matrix}β = \frac{μ ( R ) + μ ( G ) + μ ( B )}{3} \\ α = \frac{10.0}{β}\end{matrix}$$

Here, μ(R), μ(G), μ(B) are image means of red, green, and blue channels, respectively. For different cameras, this equation can be different forms with image mean μ and standard deviation σ.

In some embodiments, an adaptive exposure ratio map can be defined as follows. Here, the electronic device 101 can adjust brightness and contrast for individual pixels based on an exposure ratio map, where each pixel has its own exposure ratio in the exposure ratio map. In some cases, the exposure ratio map K (x) can be defined as follows.

$$K ( x ) = \frac{1}{max ( T ( x ) , ε )}$$

Here, ε is a small number in case T(x)=0, and T(x) is an illumination map that can be determined from a captured image I(x). T(x) simultaneously preserves the overall structure and helps to smooth the texture details of the estimated illumination L(x) from the captured image, which could be expressed as follows.

$$L ( x ) = {max}_{c ∈ \{ R , G , B \}} {I}^{c} ( x )$$

One advantage of using a guided filter here is that the guided filter can transfer the structure and smooth the texture details of the input image to form the resulting image. In some cases, this can be expressed as a minimization problem as follows.

$${min}_{T} ( {( T ( x ) - L ( x ) )}^{2} + {λ ( W ( x ) \cdot ∇ L ( x ) )}^{2} )$$

Here, W(x) is a weight matrix, and ∇L(x) is gradient of L(x). Guided filtering can compute an illumination map with fast speed and low computational load, which can fit the requirements of a VST XR pipeline or other application.

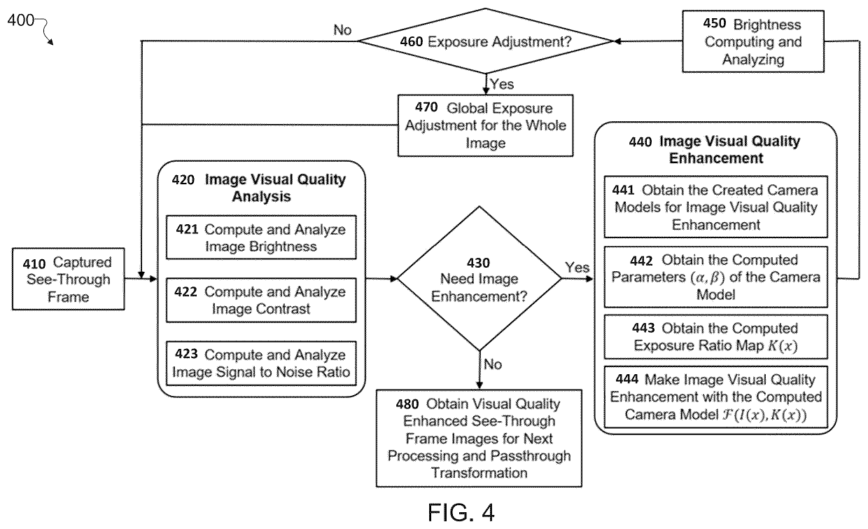

FIG. 4 illustrates an example process 400 for using adaptive camera models for selective image enhancement in real-time VST XR or other applications in accordance with this disclosure. For ease of explanation, the process 400 of FIG. 4 is described as being implemented using the electronic device 101 in the network configuration 100 of FIG. 1. However, the process 400 may be implemented using any other suitable device(s) (such as the server 106) and in any other suitable system(s).

As shown in FIG. 4, the electronic device 101 can receive a see-through frame image at step 410, such as by capturing the image frame using a camera sensor or other sensor 180. The electronic device 101 analyzes the image visual quality of the see-through frame image at step 420. At part of step 420, the electronic device 101 can compute and analyze image local and global brightness at step 421, compute and analyze image local and global contrast at step 422, and compute and analyze image local and global SNR at step 423.

The electronic device 101 can determine whether the current see-through frame image needs visual quality enhancement at step 430. This can be based on the results of the image visual quality analysis. If the visual quality of the current see-through frame image is good enough at step 430, the electronic device 101 proceeds to generate a visual quality-enhanced see-through frame image for additional processing and passthrough transformation at step 480.

If the current see-through frame image needs visual quality enhancement at step 430, the electronic device 101 can perform the image visual quality enhancement at step 440. For example, step 440 can include obtaining the camera models for image visual quality enhancement at step 441 and obtaining the computed parameters (α, β) of the camera models at step 442. Step 440 can also include obtaining the computed exposure ratio map K (x) at step 443 and performing image visual quality enhancement with the computed camera model at step 444. In some cases, for instance, step 444 can use a Beta-Gamma camera model or a Sigmoid camera model, such as in the following manner.

$$\{ \begin{matrix}ℛ ( E ( x ) ) = {e}^{{β ( 1 - E ( x ) )}^{α}} \\ ℱ ( I ( x ) , k ) = {e}^{β ( 1 - {k}^{α} )} {I ( x )}^{{k}^{α}}\end{matrix}$$

$$\{ \begin{matrix}ℛ ( E ( x ) ) = ( 1 + α ) \frac{{E ( x )}^{β}}{{E ( x )}^{β} + α} \\ ℱ ( I ( x ) , k ) = \frac{{k}^{β} I ( x ) ( 1 + α )}{( {k}^{β} - 1 ) I ( x ) + 1 + α}\end{matrix}$$

The electronic device 101 can analyze and compute the brightness of the overall scene or environment for the current see-through frame image at step 450. This process can determine the brightness of the overall scene of the enhanced image.

The electronic device 101 can determine, based on the brightness analysis, whether the overall scene or environment for the current see-through frame image needs exposure adjustments at step 460. This process can determine whether, after enhancement, the enhanced image is bright enough overall after accounting for brightness variations in elements of the image, or if global exposure adjustment is needed.

If no global exposure adjustment is needed (NO), the enhanced see-through frame image can be optionally displayed to a user and can be fed back to step 420 for further refinement. If global exposure adjustment is needed (YES), the electronic device 101 can perform global exposure adjustment for the whole see-through frame image; the enhanced see-through frame image can then be optionally displayed to a user and can be fed back to step 420 for further refinement.

Although FIG. 4 illustrates one example of a process 400 for using adaptive camera models for selective image enhancement in real-time VST XR or other applications, various changes may be made to FIG. 4. For example, while shown as a series of steps, various steps in FIG. 4 could overlap, occur in parallel, occur in a different order, or occur any number of times (including zero times).

Note that various alternative embodiments for the disclosed embodiments are possible. For example, in the process above, the electronic device 101 performs the image enhancement with adaptive camera models before final view frame generation and immediately after see-through frame capture to improve image visual quality for the pipeline. In other embodiments, the electronic device 101 can apply the created image enhancement with adaptive camera models after final view frame generation with passthrough transformation. In this way, the image enhancement process can be applied to the final view frames by considering both lighting environments when capturing the frames and the brightness effects of passthrough transformations. The enhanced frames could be immediately provided to a user or used in any other suitable manner.

As another example, in the process above, the electronic device 101 analyzes the brightness of the whole image after local enhancement with the adaptive camera models for further adjusting image brightness globally with exposure adjustment. In other embodiments, the electronic device 101 can detect image visual quality again to obtain global image quality parameters including brightness, contrast, and SNR. The electronic device 101 can also determine, according to these parameters, whether to adjust the global quality by enhancing image brightness, contrast, and SNR. For example, the electronic device 101 can adjust global brightness with exposure adjustment, adjust contrast with Gamma correction or histogram equalization, and noise reduction with Gaussian smoothing with edge preserving. In this way, the electronic device 101 can further make visual quality consistent for the whole image.

Disclosed processes for image visual quality enhancement for VST XR or other applications provide various technical improvements over other approaches. For example, disclosed embodiments improve image visual quality of see-through camera frames, provide clearer final views to users for their surroundings, and provide excellent user experiences in using VST XR products. Disclosed embodiments can also improve image brightness and contrast adjustment for VST XR or other applications, such as by enhancing image brightness and image contrast for see-through frames to make the frames clearer under any light conditions (including low-light, normal light, and high-light) so that a user can feel more comfortable while using the VST XR products. Disclosed embodiments can further provide image visual quality enhancement for general image processing and image enhancement, such as by providing improved image visual quality (including image brightness, image contrast, and SNR) for the considered images and by allowing for brightness adjustments for whole images.

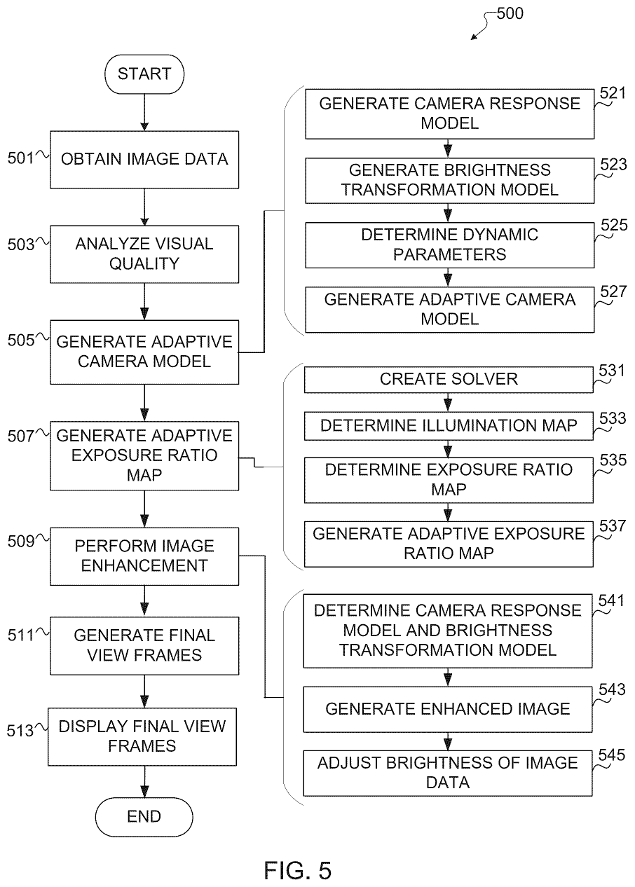

FIG. 5 illustrates an example method 500 for adaptive camera models for image enhancement in VST XR or other applications in accordance with this disclosure. For ease of explanation, the method 500 of FIG. 5 is described as being implemented using the electronic device 101 in the network configuration 100 of FIG. 1. However, the method 500 may be implemented using any other suitable device(s) (such as the server 106) and in any other suitable system(s). The method 500 represents one example of a consolidated and implementation-oriented view of the processes described above with respect to FIGS. 2 through 4 and may be performed continuously or repeatedly for successive image frames in a real-time imaging pipeline.

As shown in FIG. 5, the electronic device 101 obtains, using at least one processor 120 of electronic device 101, image data including a sequence of image frames at step 501. The image data may be captured using one or more see-through cameras and may include color image frames, depth information, or other auxiliary sensor data. In some embodiments, the image data corresponds to a real-world scene captured for passthrough presentation to a user via a VST XR display system. In various implementations, this step can correspond generally to the data collection operations described with respect to step 210 of FIG. 2 and step 310 of FIG. 3.

The electronic device 101 analyzes image visual quality of the image data at step 503. This analysis may include evaluating one or more visual quality metrics, such as brightness, contrast, dynamic range, noise level, or signal-to-noise ratio, either globally for an entire frame or locally for one or more regions within the frame. The visual quality analysis may further be used to derive statistical properties of the image data, including channel-wise means, variances, or other descriptors that characterize the lighting conditions of the captured scene. This analysis is consistent with the visual quality detection and analysis operations described with respect to step 220 of FIG. 2, step 320 of FIG. 3, and step 420 of FIG. 4.

The electronic device 101 generates an adaptive camera model by modeling a light environment associated with the image data at step 505. In various implementations, this step corresponds to the adaptive camera model creation described with respect to step 230 of FIG. 2 and step 330 of FIG. 3. In some embodiments, generating the adaptive camera model at step 505 can include generating one or more camera response models at step 521, where the camera response models characterize the mapping between scene irradiance and pixel intensity values. Generating the adaptive camera model at step 505 can include generating one or more image brightness transformation models at step 523, where the brightness transformation models account for exposure-related effects. Generating the adaptive camera model at step 505 can include determining one or more dynamic parameters based on the analyzed image visual quality at step 525. In various embodiments, the dynamic parameters represent image-dependent and environment-dependent quantities that are determined from the image visual quality analysis and used to adapt the camera models and exposure ratio maps. The dynamic parameters may be recomputed for each image frame or for groups of image frames and may vary in response to changes in scene illumination, contrast distribution, or noise characteristics. Generating the adaptive camera model at step 505 can include generating the adaptive camera model based on the one or more camera response models, the one or more image brightness transformation models, and the one or more dynamic parameters at step 527, such that the resulting model adapts to variations in lighting conditions across different frames or scenes.

In some embodiments, the dynamic parameters include image statistical parameters derived from the image data, such as one or more of mean intensity values, standard deviation values, or higher-order statistics of pixel intensity distributions. These statistics may be computed globally for an entire image frame or separately for individual color channels, such as red, green, and blue channel means and variances, and may be used to characterize overall scene brightness and contrast. Also, in some embodiments, the dynamic parameters include camera model control parameters used for brightness and contrast adjustment within the adaptive camera model. For example, when a Beta-Gamma model or a Sigmoid model is used, the dynamic parameters may include brightness control parameters, contrast control parameters, nonlinearity parameters, or shape parameters that govern the response curve of the camera response function and the brightness transformation function. These parameters may be computed as functions of the image mean and standard deviation so that the camera model adapts to different lighting conditions.

In some embodiments, the dynamic parameters include exposure-related parameters, such as exposure ratios or scaling factors that control local or global brightness adjustment. These parameters may be incorporated into the adaptive exposure ratio map and may vary spatially across the image frame to enable pixel-level or region-level exposure adjustment based on the estimated illumination map. Also, in some embodiments, the dynamic parameters include visual quality indicators, such as parameters derived from estimated image signal-to-noise ratio, local contrast measures, or low-light detection metrics. These parameters may influence the strength or selection of image enhancement operations, including the degree of brightness amplification or contrast enhancement applied to different regions of an image. Further, in some embodiments, the dynamic parameters further include calibration-influenced parameters, such as parameters derived from manufacturer-provided camera calibration data or previously stored camera response characteristics, which are adjusted dynamically based on the current image statistics and lighting environment.

Accordingly, the dynamic parameters collectively enable the adaptive camera model and adaptive exposure ratio map to respond to changing lighting conditions, scene content, and capture characteristics, thereby supporting consistent image visual quality enhancement across a wide range of environments in VST XR and other imaging applications.

The electronic device 101 generates an adaptive exposure ratio map by modeling the light environment associated with the image data at step 507. The adaptive exposure ratio map may incorporate dynamic parameters so that exposure adjustments vary spatially across individual pixels or regions of the image frame. In various implementations, this step can correspond to the exposure ratio map generation and illumination map generation described with respect to step 240 of FIG. 2 and step 350 of FIG. 3. In some embodiments, generating the adaptive exposure ratio map at step 507 includes creating a solver for a minimization problem at step 531, used to estimate an illumination map from the image data. Generating the adaptive exposure ratio map at step 507 can include determining an illumination map using the solver at step 533, determining an exposure ratio map using the illumination map at step 535, and generating the adaptive exposure ratio map based on the exposure ratio map at step 537. The adaptive exposure ratio map may further incorporate dynamic parameters so that exposure adjustments vary spatially across individual pixels or regions of the image frame.

The electronic device 101 performs image enhancement using the adaptive camera model and the adaptive exposure ratio map to produce enhanced image data at step 509. In various implementations, this step can correspond to the image enhancement operations described with respect to step 250 of FIG. 2, step 360 of FIG. 3, and step 440 of FIG. 4. In some embodiments, performing image enhancement at step 509 includes determining a camera response model and a brightness transformation model at step 541, generating an enhanced image using the camera response model, the brightness transformation model, and the adaptive exposure ratio map at step 543, and adjusting brightness of the image data at step 545. In some embodiments, this step may include both local, pixel-level enhancement and optional global exposure adjustment, as described with respect to steps 450 and 460 of FIG. 4.

The electronic device 101 generates final view frames based on the enhanced image data at step 511. This step can correspond generally to the final view frame generation and rendering described with respect to step 260 of FIG. 2, steps 370 and 380 of FIG. 3, and step 480 of FIG. 4. The generation of final view frames may include applying one or more passthrough transformations, distortion corrections, or head pose compensation operations prior to rendering. The electronic device 101 initiates display of the final view frames on at least one display at step 513. This step may include transmitting the final view frames to one or more display panels or display controllers and corresponds to the display operations described with respect to step 260 of FIG. 2 and step 382 of FIG. 3. Initiating display may occur in real time as part of a continuous VST XR rendering pipeline.

Accordingly, the method 500 of FIG. 5 can function as a unified, end-to-end representation of adaptive camera modeling, exposure ratio map generation, and image enhancement for VST XR or other applications. By integrating processes such as those illustrated in FIGS. 2, 3, and 4 into a single method flow, FIG. 5 illustrates how dynamic light environment modeling and adaptive image enhancement may be implemented in practice to provide consistent and improved image visual quality across varying lighting conditions.

Although FIG. 5 illustrates one example of a method 500 for adaptive camera models for image enhancement in VST XR or other applications, various changes may be made to FIG. 5. For example, while shown as a series of steps, various steps in FIG. 5 could overlap, occur in parallel, occur in a different order, or occur any number of times (including zero times).

It should be noted that the functions shown in the figures or described above can be implemented in an electronic device 101, 102, 104, server 106, or other device(s) in any suitable manner. For example, in some embodiments, at least some of the functions shown in the figures or described above can be implemented or supported using one or more software applications or other software instructions that are executed by the processor 120 of the electronic device 101, 102, 104, server 106, or other device(s). In other embodiments, at least some of the functions shown in the figures or described above can be implemented or supported using dedicated hardware components. In general, the functions shown in the figures or described above can be performed using any suitable hardware or any suitable combination of hardware and software/firmware instructions. Also, the functions shown in the figures or described above can be performed by a single device or by multiple devices.

Although this disclosure has been described with reference to various example embodiments, various changes and modifications may be suggested to one skilled in the art. It is intended that this disclosure encompass such changes and modifications as fall within the scope of the appended claims.

What is claimed is:

1. A method comprising:
obtaining, using at least one processing device of an electronic device, image data including a sequence of image frames;
analyzing, using the at least one processing device, image visual quality of the image data;
generating, using the at least one processing device, an adaptive camera model by modeling a light environment associated with the image data;
generating, using the at least one processing device, an adaptive exposure ratio map by modeling the light environment associated with the image data;
performing, using the at least one processing device, image enhancement using the adaptive camera model and the adaptive exposure ratio map to produce enhanced image data;
generating, using the at least one processing device, final view frames based on the enhanced image data; and
initiating display of the final view frames on at least one display.

2. The method of claim 1, wherein generating the adaptive camera model includes:
generating one or more camera response models;
generating one or more image brightness transformation models;
determining one or more dynamic parameters; and
generating the adaptive camera model based on the one or more camera response models, the one or more image brightness transformation models, and the one or more dynamic parameters.

3. The method of claim 1, wherein generating the adaptive exposure ratio map includes:
creating a solver for a minimization problem;
determining an illumination map using the solver;
determining an exposure ratio map using the illumination map; and
generating the adaptive exposure ratio map based on the exposure ratio map and one or more dynamic parameters.

4. The method of claim 1, wherein performing the image enhancement includes:
determining a camera response model and a brightness transformation model;
generating an enhanced image using the camera response model, the brightness transformation model, and the adaptive exposure ratio map; and
adjusting brightness of the image data.

5. The method of claim 1, wherein generating the adaptive camera model includes using a Beta-Gamma model or a Sigmoid model.

6. The method of claim 1, wherein the electronic device is a head-mounted device configured to capture a scene using at least one camera and present corresponding images on the at least one display.

7. The method of claim 6, wherein the at least one camera comprises at least one see-through camera.

8. An electronic device comprising:
at least one processing device configured to:
obtain image data including a sequence of image frames;
analyze image visual quality of the image data;
generate an adaptive camera model by modeling a light environment associated with the image data;
generate an adaptive exposure ratio map by modeling the light environment associated with the image data;
perform image enhancement using the adaptive camera model and the adaptive exposure ratio map to produce enhanced image data;
generate final view frames based on the enhanced image data; and
initiate display of the final view frames on at least one display.

9. The electronic device of claim 8, wherein, to generate the adaptive camera model, the at least one processing device is configured to:
generate one or more camera response models;
generate one or more image brightness transformation models;
determine one or more dynamic parameters; and
generate the adaptive camera model based on the one or more camera response models, the one or more image brightness transformation models, and the one or more dynamic parameters.

10. The electronic device of claim 8, wherein, to generate the adaptive exposure ratio map, the at least one processing device is configured to:
create a solver for a minimization problem;
determine an illumination map using the solver;
determine an exposure ratio map using the illumination map; and
generate the adaptive exposure ratio map based on the exposure ratio map and one or more dynamic parameters.

11. The electronic device of claim 8, wherein, to perform the image enhancement, the at least one processing device is configured to:
determine a camera response model and a brightness transformation model;
generate an enhanced image using the camera response model, the brightness transformation model, and the adaptive exposure ratio map; and
adjust brightness of the image data.

12. The electronic device of claim 8, wherein the at least one processing device is configured to generate the adaptive camera model using a Beta-Gamma model or a Sigmoid model.

13. The electronic device of claim 8, wherein the electronic device is a head-mounted device configured to capture a scene using at least one camera and present corresponding images on the at least one display.

14. The electronic device of claim 13, wherein the at least one camera comprises at least one see-through camera.

15. A non-transitory machine readable medium containing instructions that when executed cause at least one processor of an electronic device to:
obtain image data including a sequence of color image frames;
analyze image visual quality of the image data;
generate an adaptive camera model by modeling a light environment associated with the image data;
generate an adaptive exposure ratio map by modeling the light environment associated with the image data;
perform image enhancement using the adaptive camera model and the adaptive exposure ratio map to produce enhanced image data;
generate final view frames based on the enhanced image data; and
initiate display of the final view frames on at least one display.

16. The non-transitory machine readable medium of claim 15, wherein the instructions that when executed cause the at least one processor to generate the adaptive camera model comprise instructions that when executed cause the at least one processor to:
generate one or more camera response models;
generate one or more image brightness transformation models;
determine one or more dynamic parameters; and
generate the adaptive camera model based on the one or more camera response models, the one or more image brightness transformation models, and the one or more dynamic parameters.

17. The non-transitory machine readable medium of claim 15, wherein the instructions that when executed cause the at least one processor to generate the adaptive exposure ratio map comprise instructions that when executed cause the at least one processor to:
create a solver for a minimization problem;
determine an illumination map using the solver;
determine an exposure ratio map using the illumination map; and
generate the adaptive exposure ratio map based on the exposure ratio map and one or more dynamic parameters.

18. The non-transitory machine readable medium of claim 15, wherein the instructions that when executed cause the at least one processor to perform the image enhancement comprise instructions that when executed cause the at least one processor to:
determine a camera response model and a brightness transformation model;
generate an enhanced image using the camera response model, the brightness transformation model, and the adaptive exposure ratio map; and
adjust brightness of the image data.

19. The non-transitory machine readable medium of claim 15, wherein the instructions when executed cause the at least one processor to generate the adaptive camera model using a Beta-Gamma model or a Sigmoid model.

20. The non-transitory machine readable medium of claim 15, wherein the electronic device is a head-mounted device configured to capture a scene using at least one camera and present corresponding images on the at least one display.
